(19) United States
(12) Patent Application Publication
(10) Pub. No.: US 2025/0008335 A1
(43) Pub. Date: Jan. 2, 2025

(54) METHODS FOR RESOURCE COORDINATION AMONG THE NEIGHBOURING RAN NODES OVER NETWORK INTERFACES

(71) Applicant: Telefonaktiebolaget LM Ericsson (publ), Stockholm (SE)

(72) Inventors: Ali Parichehrehteroujeni, Linkoping (SE); Angelo Centonza, Granada (ES)

(21) Appl. No.: 18/708,863

(22) PCT Filed: Nov. 9, 2022
(86) PCT No.: PCT/IB2022/060804

§ 371 Date: May 9, 2024

Related U.S. Application Data
(60) Provisional application No. 63/277,491, filed on Nov. 9, 2021.

(51) Int. Cl. H04W 16/10; H04W 92/12

(52) U.S. Cl. CPC H04W 16/10; H04W 92/12

(57) ABSTRACT

Methods and systems are described for coordinating resources among neighbouring network nodes and cells in a telecommunications network. Neighbouring cells or nodes may experience conflicts, such as co-channel interference. To enable coordination among nodes or cells it has been required to establish a full-fledge cell to cell relation with a network interface. This can be cost and resource intensive, even if most features over the interface remain unused. Systems and methods are disclosed for enabling resource coordination without incurring a full-fledged relation between cells, allowing for more efficient use of resources.

### CROSS REFERENCE TO RELATED INFORMATION

This application claims the benefit of United States of America priority application No. 63/277,491, filed on Nov. 9, 2021, titled “Methods for resource coordination among the neighbouring RAN nodes over network interfaces.”

### TECHNICAL FIELD

The present disclosure generally relates to the technical field of wireless communications and more particularly to resource coordination among neighbouring nodes.

### BACKGROUND

The current 5G RAN (NG-RAN (Next Generation-Radio Access Network)) architecture is depicted and described in 3GPP TS 38.401 version 16.5.0. The overall architecture of NG-RAN is illustrated with FIG. 1.

### NR Architecture

NG-RAN comprises a set of gNBs (base station in NR (New Radio)) connected to the 5GC (5G Core) through the NG. A gNB can support FDD (Frequency Division Duplex) mode, TDD (Time Division Duplex) mode or dual mode operation. And gNBs can be interconnected through the Xn interface (the interface between two gNBs in NR). A gNB may consist of a gNB-CU (central unit) and gNB-DUs (distributed units). A gNB-CU and a gNB-DU are inter-connected via a logical interface called F1. One gNB-DU is connected to preferably only one gNB-CU. For resiliency, a gNB-DU may be connected to multiple gNB-CU by appropriate implementation.

NG, Xn and F1 are logical interfaces. The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and control plane (signaling) transport. If security protection for control plane and user plane data on TNL of NG-RAN interfaces has to be supported, NDS/IP (Network Domain Security/Internet Protocol) (3GPP TS 33.401) shall be applied.

A gNB may also be connected to an LTE (Long Term Evolution) eNB (Evolved NodeB (LTE base station)) via the X2 interface (the interface between two eNBs in LTE). Another architectural option is that where an LTE eNB connected to the Evolved Packet Core network is connected over the X2 interface with a so called en-gNB. The latter is a gNB not connected directly to a CN and connected via X2 to an eNB for the sole purpose of performing dual connectivity.

The architecture in FIG. 1 can be expanded by spitting the gNB-CU into two entities (See FIG. 2). In the split architecture option, the RAN protocol stack functionality is separated in different parts. The gNB-CU-CP (or CU-CP (Central Unit-Control Plane)) is expected to handle the RRC (Radio Resource Control) layer, the gNB-CU-UP (or CU-UP (Central Unit-User Plane)) will handle the PDCP (Packet Data Convergence Protocol) layer and the gNB-DU will handle the RLC, MAC (Medium Access Control) and PHY (physical) layer of the protocol stack. In some further split the gNB-DU can have separated unit that handles the PHY parts separately compared to RLC and MAC layers that are handled in a gNB-DU.

As different units handle different protocol stack functionalities, there will be a need for inter-node communication between the gNB-DU, the gNB-CU-UP and the gNB-CU-CP. This is achieved via the F1-C interface related to control plane signaling, via the F1-U interface related to user plane signaling for communication between gNB-CU and gNB-DU and via the E1 interface for communication between gNB-CU-UP and gNB-CU-CP.

The E1 interface is a logical interface. It supports the exchange of signaling information between the endpoints. From a logical standpoint, the E1 interface is a point-to-point interface between a gNB-CU-CP and a gNB-CU-UP. The E1 interface enables exchange of UE (user equipment) associated information and non-UE associated information. The E1 interface is a control interface and is not used for user data forwarding.

### Random Access in NR

Random access (RA) is performed when the UE wants to transition from idle/inactive to connected state to e.g., transmit data or signaling. Similar to LTE, NR uses a four-step random access procedure with the following steps (see FIG. 3):
1—UE transmits a preamble (also known as Msg1) on the physical random access channel (RACH)
2—Network responds with a random access response (RAR) (also known as Msg2) indicating reception of the preamble and providing a time-alignment command adjusting the transmission timing of the UE based on the timing of the received preamble
3-4—The UE and network exchange messages (uplink message Msg3 and subsequent downlink message Msg4) to resolve potential collisions due to simultaneous transmission of the same preamble from multiple devices within the cell.

If successful, Msg4 also transfers the UE to connected states. Once the random access is completed, the UE is in connected state and subsequent communication is performed using dedicated channels.

In addition to the basic 4-step random access procedure described above, NR Release 16 also supports a 2-step random access procedure consisting of only two messages MsgA and MsgB, where MsgA basically replaces Msg1+Msg3 and MsgB basically replaces Msg2+Msg4 (see FIG. 4). The 2-step random access procedure reduces the idle-to-connected transition time but is in practice limited to small cells where the timing advance is 0 since the Msg3 (or PUSCH (Physical Uplink Shared Channel)) part of MsgA is sent before the uplink timing alignment is established.

What is described above is the so-called contention-based random-access procedure where there is no coordination among the UEs and the same preamble may therefore be sent from multiple UEs at the same time. In connected mode there is also a contention-free random-access procedure, which is used e.g., during handover, where the network assigns a dedicated preamble for the UE to use in the random-access procedure and hence there are no collisions. A focus of the present disclosure is the contention-based random-access procedure.

### RACH Optimization

Optimization of the RACH configuration in cells is a Release 9 SON (Self Optimized Network) feature that is key to optimizing the system performance of a mobile network. A poorly configured RACH may result in higher call setup and handover delays due to frequent RACH collisions, or low preamble-detection probability and limited coverage. The amount of uplink resource reserved for RACH also affects the system capacity. Therefore, a network operator should carefully monitor that the RACH parameters are appropriately set, considering factors such as the RACH load, the uplink interference, the traffic patterns and the population under the cell coverage.

The RACH optimization feature facilitates automatic configuration of PRACH (Physical RACH) parameters (including the PRACH resource configuration, preamble root sequence and cyclic shift configuration) to avoid preamble collisions with neighboring cells. The principle of this automatic configuration is similar to the automatic PCI (Physical Cell Identity) configuration SON feature: the PRACH configuration information is included in the ‘X2 Setup’ and ‘eNB Configuration Update’ procedures in LTE. Therefore, whenever a new eNB is initialized and learns about its neighbors via the ANR (Automatic Neighbour Relation) function, it can at the same time learn the neighboring PRACH configurations. It can then select its own PRACH configuration to avoid conflicts with the neighboring ones. This is facilitated if the neighboring eNBs/cells are synchronized.

Whenever a conflict is identified, one of the cells should change its configuration, but the algorithm for selecting which cell should change and in what manner is not specified. The network operator can also combine PRACH self-optimization with manual configuration if necessary, but this is typically more prone to errors and more time consuming than automatic RACH optimization.

### RACH-Related Signaling Over the X2 Interface in LTE

A description can now be given of RACH related signaling over the X2 interface in LTE networks. Generally, a RAN node may trigger an analysis of the information reported by one or more UEs internally or in coordination with other RAN nodes. In this regard, as a part of the LTE solution, the eNB PRACH configuration parameters can be exchanged over the X2 interface using X2AP (X2 Application Protocol) signaling procedures involving X2 SETUP REQUEST/X2 SETUP RESPONSE message exchange and ENB CONFIGURATION UPDATE/ENB CONFIGURATION UPDATE ACKNOWLEDGE message exchange, where the PRACH Configuration IE (Information Element), shown in the table in FIG. 5, is contained in the Served Cell Information IE. This IE indicates the PRACH resources used in neighbor cell.

Such information can be exchanged between RAN nodes with cells identified as neighboring cells. Neighboring cells would be identified by RRM (Radio Resource Management) measurements provided by UEs. Upon detection of a new neighbor a RAN node may request to set up an X2 interface and later update the configurations if changed. This will be accomplished as part of X2 SETUP REQUEST or ENB CONFIGURATION UPDATE X2AP signaling which includes the PRACH Configuration IE as part of the Served Cell Information IE.

In addition to the above-mentioned mechanism to exchange RACH related configuration information over the X2 interface as part of X2 setup and eNB configuration update signaling, a Uu-based (the air interface for LTE and 5G NR) signaling mechanism has been defined to use UE assistance information to detect the potential issues, and further enhance the RACH performance by performing finer optimization relying on the provided UE assistance information.

### E-UTRA-NR Cell Resource Coordination

E-UTRA-NR (Evolved Universal Terrestrial Radio Access-NR) Cell Resource Coordination can now be described. The purpose of the E-UTRA-NR Cell Resource Coordination procedure is to enable coordination of radio resource allocation between an ng-eNB and a gNB that are sharing spectrum and whose coverage areas are fully or partially overlapping. During the procedure, the ng-eNB and gNB shall exchange their intended resource allocations for data traffic, and, if possible, converge to a shared resource. The procedure is only to be used for the purpose of E-UTRA-NR spectrum sharing. The procedure can use non-UE-associated signalling.

If case of network sharing with multiple cell ID broadcast with shared Xn-C signalling transport, as specified in TS 38.300, the E-UTRA-NR CELL RESOURCE COORDINATION REQUEST message and the E-UTRA-NR CELL RESOURCE COORDINATION RESPONSE message should include the Interface Instance Indication IE to identify the corresponding interface instance.

FIG. 6 shows an ng-eNB (node providing E-UTRA user plane and control plane protocol terminations towards the UE, and connected via the NG interface to the 5GC) initiated E-ULTRA-NR Cell Resource Coordination requestion, with a successful operation. An ng-eNB initiates the procedure by sending the E-UTRA-NR CELL RESOURCE COORDINATION REQUEST message to an gNB over the Xn interface. The gNB extracts the Data Traffic Resource Indication IE and it replies by sending the E-UTRA-NR CELL RESOURCE COORDINATION RESPONSE message. The gNB shall calculate the full ng-eNB resource allocation by combining the Data Traffic Resource Indication IE and the Protected E-UTRA Resource Indication IE that were most recently received from the ng-eNB. In case of conflict between the most recently received Data Traffic Resource Indication IE and the most recently received Protected E-UTRA Resource Indication IE, the gNB shall give priority to the Protected E-UTRA Resource Indication IE.

FIG. 7 shows a gNB initiated E-ULTRA-NR Cell Resource Coordination requestion, with a successful operation. An gNB initiates the procedure by sending the E-UTRA-NR CELL RESOURCE COORDINATION REQUEST message to an ng-eNB. The ng-eNB replies with the E-UTRA-NR CELL RESOURCE COORDINATION RESPONSE message. In case of conflict between the most recently received Data Traffic Resource Indication IE and the most recently received Protected E-UTRA Resource Indication IE, the gNB shall give priority to the Protected E-UTRA Resource Indication IE.

### ANR Function

Description from 3GPP TS 36.300 can help in explaining the details of the neighbour relations among the neighbouring RAN nodes.

The purpose of the ANR function is to relieve the operator from the burden of manually managing Neighbour Cell Relations (NCRs). FIG. 8 shows ANR and its environment. The ANR function resides in the eNB and manages the conceptual Neighbour Cell Relation Table (NCRT). Located within ANR, the Neighbour Detection Function finds new neighbours and adds them to the NCRT. ANR also contains the Neighbour Removal Function which removes outdated NCRs. The Neighbour Detection Function and the Neighbour Removal Function are implementation specific.

An NCR in the context of ANR is defined as follows. An existing Neighbour Relation from a source cell to a target cell means that eNB controlling the source cell:
1. Knows the ECGI/CGI (E-UTAN Cell Global Identifier or Cell Global Identifier) and PCI of the target cell;
2. Has an entry in the NCRT for the source cell identifying the target cell; and
3. Has the attributes in this NCRT entry defined, either by O&M (Operation and Maintenance) or set to default values.

For each cell that the eNB has, the eNB keeps a NCRT, see FIG. 8. For each NCR, the NCRT contains the Target Cell Identifier (TCI), which identifies the target cell. For E-UTRAN, the TCI corresponds to the ECGI and PCI of the target cell. Furthermore, each NCR has three attributes, the NoRemove, the NoHO and the NoX2 attribute. These attributes have the following definitions:
1. No Remove: If checked, the eNB shall not remove the NCR from the NCRT.
2. No HO: If checked, the NCR shall not be used by the eNB for handover reasons.
3. No X2: If checked, the Neighbour Relation shall not use an X2 interface in order to initiate procedures towards the eNB parenting the target cell.

NCRs are cell-to-cell relations, while an X2 link is set up between two eNBs. NCRs are unidirectional, while an X2 link is bidirectional. The neighbour information exchange, which occurs during the X2 Setup procedure or in the eNB Configuration Update procedure, may be used for ANR purposes. The ANR function also allows O&M to manage the NCRT. O&M can add and delete NCRs. It can also change the attributes of the NCRT. The O&M system is informed about changes in the NCRT.

### SUMMARY

One embodiment under the present disclosure comprises a method performed by an OAM (Operation, Administration, Maintenance) node for configuring an attribute configuration between a first cell served by a first network node and a second cell served by a second network node. The method comprises configuring at least one attribute configuration at the first network node and at the second network node, wherein the at least one attribute configuration identifies at least one service to be used over an interface between the first cell and the second cell.

Another embodiment of a method under the present disclosure is a method performed by a first network node for configuring an attribute configuration between a first cell served by the first network node and a second cell served by a second network node. The method comprises receiving, from an OAM, at least one attribute configuration, wherein the at least one attribute configuration identifies at least one service to be used over an interface between the first cell and the second cell. It further comprises setting up the interface between the first cell and the second cell; and using the at least one service over the interface.

Another embodiment comprises a method performed by a first network node for managing an attribute configuration of a first cell served by the first network node. The method comprises setting at least one attribute configuration at the first network node as part of a neighbour relation between the first cell and a second cell served by a second network node; and determining at least one service identified by the at least attribute configuration to be used over an interface between the first cell and the second cell. The method also includes indicating the at least one service and at least one attribute configuration to the second network node; establishing the interface; and implementing the at least one service over the established interface.

Another possible embodiment under the present disclosure is a method performed by a first network node co-located with a second network node for performing resource coordination with a third network node using the same frequency band as a first cell served by the first network node. The method comprises configuring a neighbour relation for a second cell served by the second network node, wherein the neighbour relation identifies at least one service to be used over an interface between the first cell and the second cell. The method also includes indicating the neighbour relation and the at least one service to the second network node; and coordinating one or more resources with the second network node such that neighbouring cells between the first network node and the third network node can coexist on a shared channel.

An additional embodiment comprises a network node or component for configuring a neighbour relation between a first cell and a second cell for a specific service. The node or component comprises processing circuitry configured to perform any of the steps of any of the network node or component (e.g., OAM, O&M) based methods described herein. It furthers comprises power supply circuitry configured to supply power to the processing circuitry.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates overall NG-RAN architecture;

FIG. 2 illustrates split gNB architecture in NG-RAN;

FIG. 3 shows a flow-chart of a four-step random access procedure;

FIG. 4 shows a flow-chart of a two-step random access procedure;

FIG. 5 shows a table of example PRACH Configuration information elements;

FIG. 6 illustrates a flow-chart of a successful operation of an ng-eNB-initiated E-UTRA-NR Cell Resource Coordination request;

FIG. 7 illustrates a flow-chart of a successful operation of an gNB-initiated E-UTRA-NR Cell Resource Coordination request;

FIG. 8 illustrates an embodiment of interaction between an eNB and O&M due to ANR;

FIG. 9 illustrates a typical 4G wireless network deployment;

FIG. 10 illustrates a flow-chart of a method embodiment for resource coordination among two network nodes under the present disclosure;

FIG. 11 illustrates a flow-chart of a method embodiment for resource coordination among three network nodes under the present disclosure;

FIG. 12 illustrates a flow-chart of a method embodiment for resource coordination among two network nodes and an OAM under the present disclosure;

FIG. 13 illustrates an embodiment of interaction between a gNB and OAM due to ANR;

FIG. 14 illustrates a flow-chart of a method embodiment for resource coordination among a UE and two nodes/cells under the present disclosure;

FIG. 15 shows a schematic of a communication system embodiment under the present disclosure;

FIG. 16 shows a schematic of a user equipment embodiment under the present disclosure;

FIG. 17 shows a schematic of a network node embodiment under the present disclosure;

FIG. 18 shows a schematic of a host embodiment under the present disclosure;

FIG. 19 shows a schematic of a virtualization environment embodiment under the present disclosure; and

FIG. 20 shows a schematic representation of an embodiment of communication amongst nodes, hosts, and user equipment under the present disclosure.

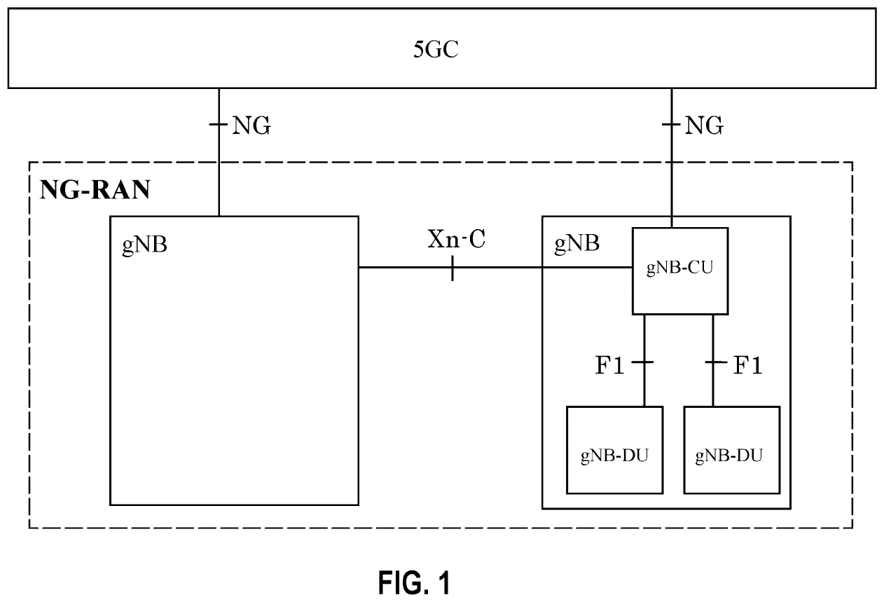

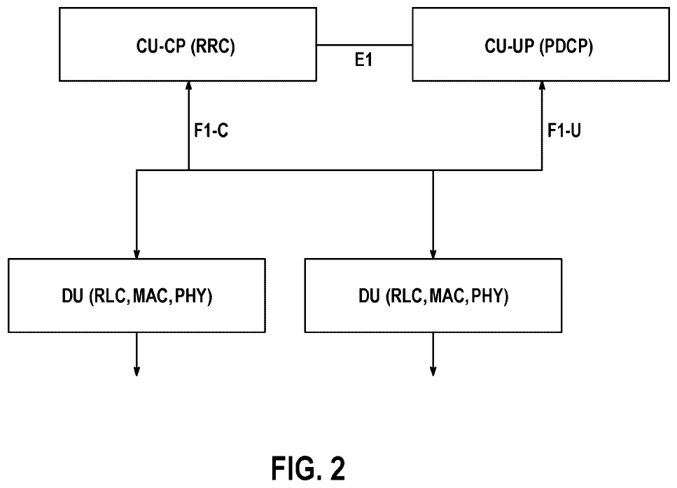

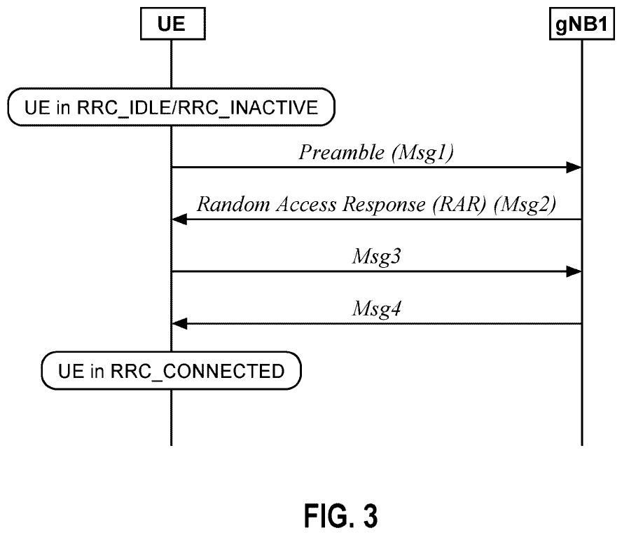

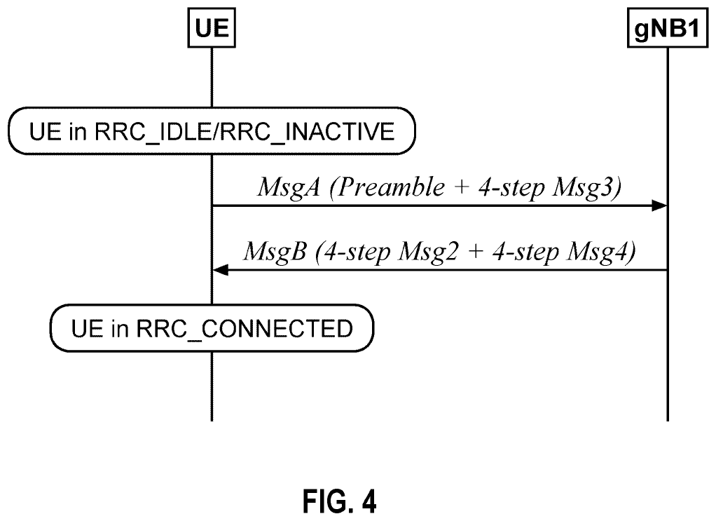

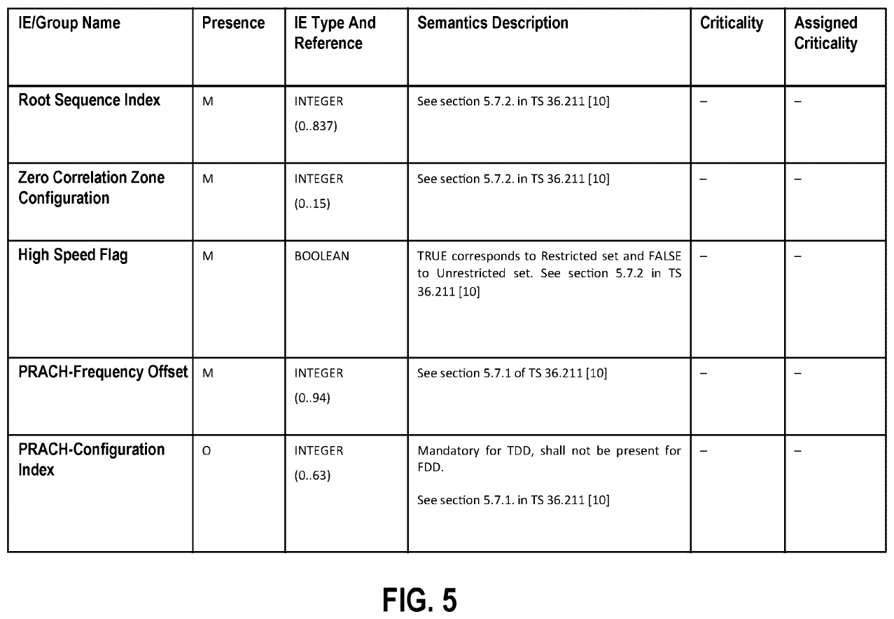

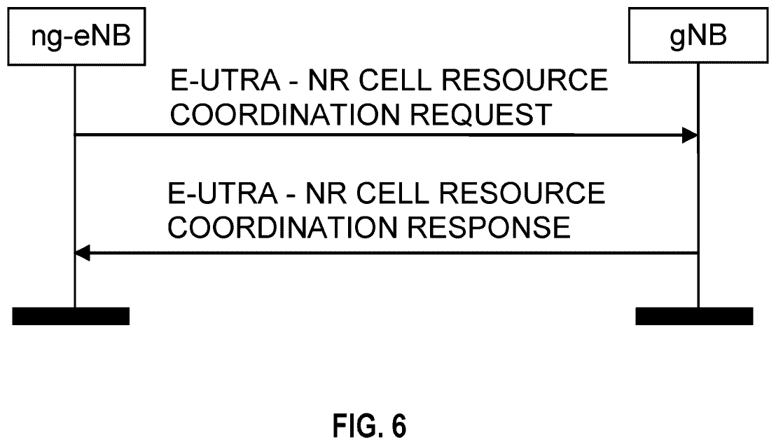

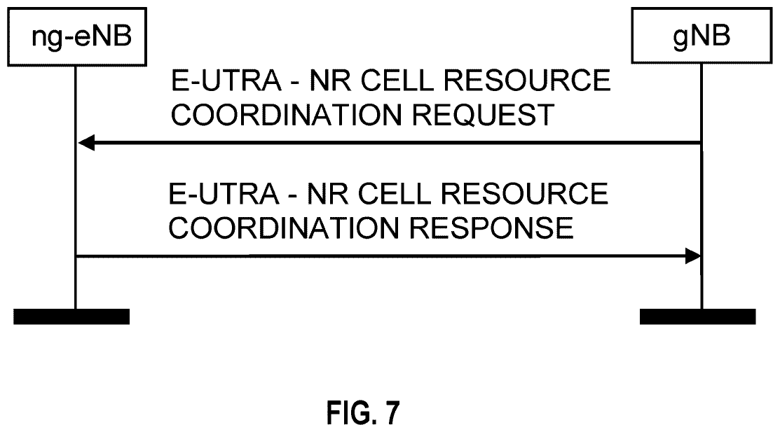

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

There currently exist certain challenges for resource coordination amongst neighbouring nodes. As described above, for each cell owned by a RAN node (in a non-limiting example an eNB), the RAN node keeps a NCRT. For each NCR, the NCRT contains the TCI, which identifies the target cell e.g., ECGI and PCI of the target cell. In addition, each NCR has three attributes, the NoRemove, the NoHO and the NoX2 attribute, as defined in the following
1. No Remove: If checked, the eNB shall not remove the NCR from the NRT;
2. No HO: If checked, the NCR shall not be used by the eNB for handover reasons;
3. No X2: If checked, the Neighbour Relation shall not use an X2 interface in order to initiate procedures towards the eNB parenting the target cell.

An attribute configuration can refer to a set of attributes and whether they are checked or not, implementing (or prohibiting) the respective functionality. A neighbour relation refers to an attribute configuration combined with identifying information of a target cell. A neighbour relation is often a line or group of data in an NCRT.

Based on these attributes the source and/or target RAN nodes will be limited in using the neighbour relation (e.g., the interface between RAN node shall not be used for the purpose of handover). However, the current approaches (explained above) do not enable the operators to establish an interface among the neighbouring RAN nodes to run specific sets of features. This drawback may cause additional costs for the network operators that, for the sake of a limited set of features to be running over the established interface, need to support the entire interface capabilities with their associated setup and configuration requirements.

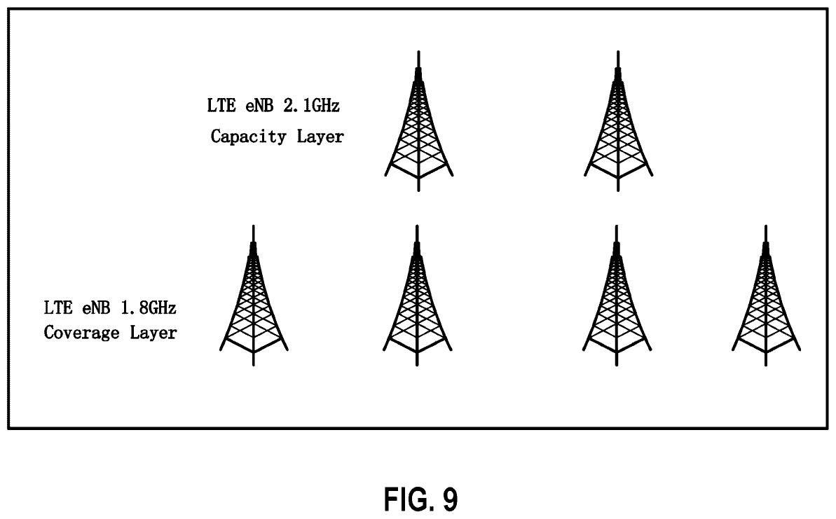

A non-limiting example problem can be described as follows. This example is based on existing issues in the real-life network that has been discussed in 3GPP RAN3 #110e meeting. In the 4G era, 1.8 GHz as the coverage layer was deployed in an urban area while 2.1 GHZ as a capacity layer was deployed in the region with high-capacity requirements. As illustrated in FIG. 9, the amount of 2.1 GHz cells is far less than that of 1.8 GHz cells. The 2.1 GHz band is considered as a good choice for NR coverage layer, too. To enable a smooth transition between LTE and NR, it would be ideal to upgrade the existing LTE 2.1 GHz sites to support the resource coordination function. With that, it could be possible to allow upgraded eNBs to connect to newly deployed gNBs, e.g. via the EN-DC (E-UTRA-NR Dual Connectivity) X2 interface, and to allow both LTE and NR to coexist within the same spectrum. It is worth noting that high numbers of NR cells in co-channel sharing with LTE are planned to be deployed to build continuous coverage for NR. As a result, the co-channel interference between an existing LTE cell in an upgraded site and a newly-built NR site would be quite prominent and a solution to fix it is needed to avoid spectrum efficiency degradation.

Certain aspects of the disclosure and their embodiments may provide solutions to these or other challenges. Embodiments under the current disclosure can support coordination of radio resource allocation between an eNB and en-gNB that are sharing spectrum via the E-UTRA-NR Cell Resource Coordination procedure. However, to take advantage of the Resource Coordination function between E-UTRA and NR cells, previously a full cell to cell relation and a network interface (e.g., EN-DC X2 interface) would be established, while most of the features over this established interface would remain unused. This can create a prohibitive cost to operators in terms of complexity, configuration and operational investments. One problem is therefore how to enable the use of resource coordination without incurring such high costs.

Certain embodiments under the present disclosure include enabling the neighbouring RAN node to configure and/or set up a neighbour relation and establish a network interface toward a neighbouring RAN node only for a specific feature/application/service (or a set of specific features, etc.) among the neighboring RAN nodes. This means that the cell-to-cell neighbour relation and the established interface between RAN nodes can be used to run only the specific features selected e.g., by means of pre-configuration. Embodiments under the present disclosure comprise methods and systems for configuring a cell-to cell neighbour relation interface among the neighbouring RAN nodes enabling the RAN nodes to run only specific set of features using the established network interface.

Certain embodiments may provide various technical advantages. Certain embodiments under the present disclosure can provide detailed means for a RAN node to use a cell-to-cell neighbour relation and an interface toward another RAN node for the purpose of running specific features e.g., resource coordination or spectrum sharing or PRACH resource coordination's. Certain method embodiments can provide the possibility to run and operate co-channel cells belonging to the non-co-located RAN nodes.

In a non-limiting example, the specific feature can be resource coordination or dynamic spectrum sharing among the neighbouring RAN nodes that own cells operating in the same or overlapping frequencies bands. In another non-limiting example, the specific feature can be PRACH configuration coordination among the neighbouring RAN nodes that own cells operating in the same or overlapping frequencies bands.

Some of the embodiments contemplated herein can now be described more fully with reference to the accompanying drawings. Embodiments are provided by way of example to convey the scope of the subject matter to those skilled in the art. For purposes of the present disclosure, it should be noted that the terms/names/abbreviations “CU”, “DU”, “CU-CP” and “CU-UP” can be considered equivalent to the respective terms/names/abbreviations “gNB-CU”, “gNB-DU”, “gNB-CU-CP” and “gNB-CU-UP.” In addition, a network node and RAN node in this disclosure are used interchangeably and can be an eNB or a gNB or, gNB-CU or eNB-CU, gNB-DU or eNB-DU. In addition, a gNB-CU may be “represented” by a gNB-CU-CP and/or an eNB-CU may be “represented” by an eNB-CU-CP.

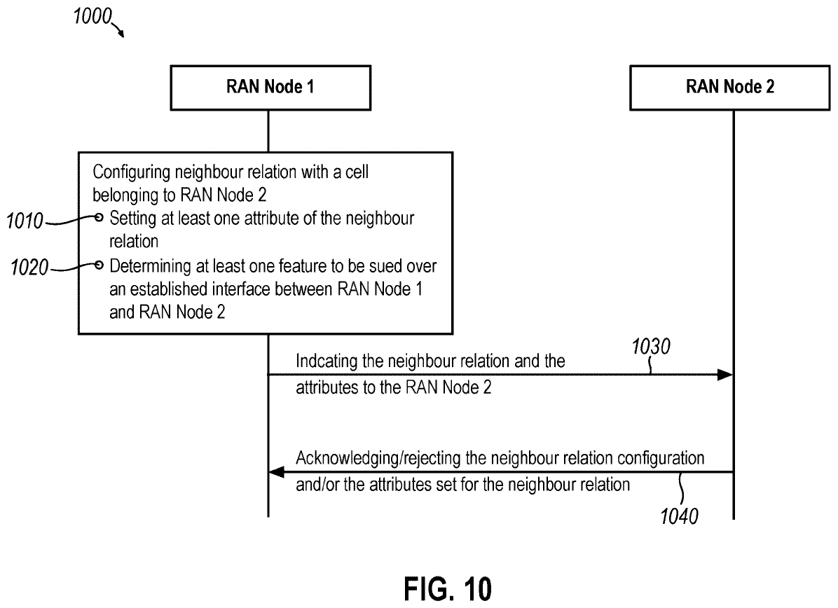

One method embodiment under the present disclosure is performed by a first network node managing the configuration of a first cell served by a first RAN node, the method sets at least one attribute at the first RAN node as part of neighbour relation configuration associated to the neighbour relation between first cell and a second cell served by a second RAN node. The method, as part of the configured attributes, determines at least one feature/service/application to be used over the established interface between RAN nodes serving the first and second cell. An embodiment of this method is shown in FIG. 10. Method 1000 is a method performed by a first network node with a first cell for managing the configuration or neighbour relation of the first cell with a second cell belonging to a second network node. Step 1010 is setting at least one attribute at the first network node as part of neighbour relation configuration between the first cell and the second cell served by the second network node. Step 1020 is determining at least one feature/service/application to be used over an established interface between the first and second network nodes (e.g., only resource coordination, only PRACH coordination). Step 1030 is indicating the neighbour relation and the at least one attribute to the second network node. Step 1040, which can be optional, is receiving an acknowledgement or rejection of the neighbour relation or the at last one attribute from the second network node. After this, an interface can be established and the feature, service or application can be run across the interface between the first and second cells.

Method 1000 can comprise a variety of additional or alternative steps or modifications. In an embodiment, the neighbour relation is configured as part of the NCRT and the associated configuration indicates that the network interface between RAN nodes will be used only for the purpose of Resource Coordination or only for dynamic Spectrum Sharing among the neighbouring cells owned by the neighbouring RAN nodes. In another embodiment, the neighbour relation is configured as part of the NCRT and the associated configuration indicates that the network interface between RAN nodes will be used only for the purpose of PRACH resource coordination e.g., to resolve the conflict among the neighbouring network nodes.

In one embodiment the first network node and the first or second RAN node may be the same node, namely any of the RAN node serving one of the neighbouring cells can configure the attribute that determines which feature the interface allows to use.

In yet another embodiment, the attributes concerning the allowed feature/service/application between first and second network node are set by the operation, administration, and maintenance (OAM) node. In yet another embodiment, the attributes concerning the allowed feature/service/application between first and second network node are set by the Service Management & Orchestrator (SMO) node. The terms “feature,” “service,” and “application” can be used interchangeably in the present disclosure. Each can refer to a variety of applications, functionalities, features, services, programs, algorithms, behaviors or other similar aspects of a network node or cell and/or their relationship to other nodes or cells.

In all the embodiments above, the attributes configured imply that the functionalities needed to setup and maintain the interface running in a correct and efficient way will still be carried out. Namely, features such as interface setup, transport network association maintenance, configuration updates may be allowed to run even if the attributes restrict the functionalities that can be used over the interface.

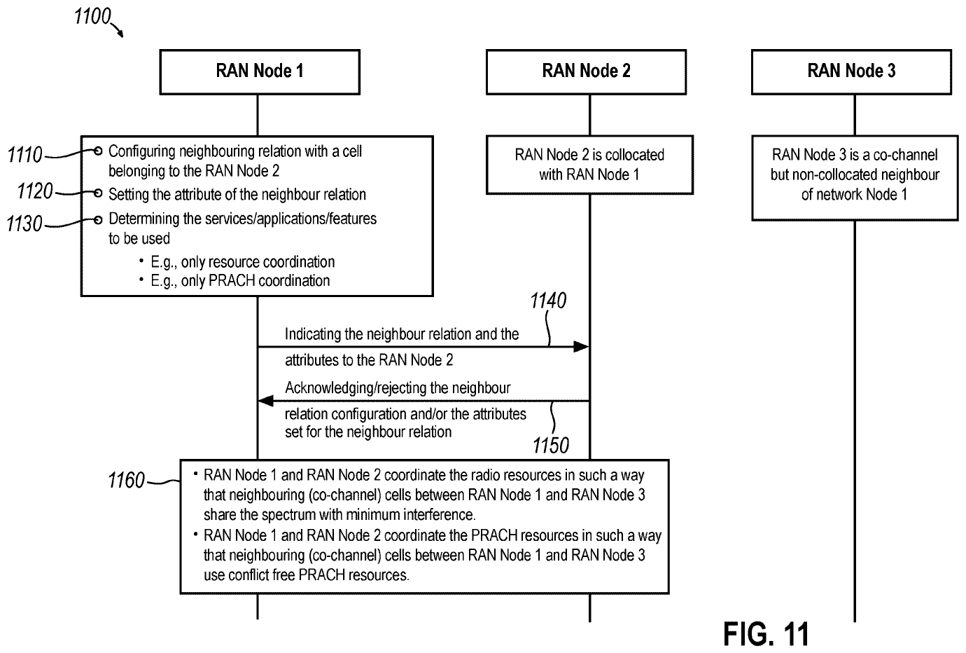

In yet another embodiment, the first RAN node or the second RAN node (that are co-located e.g., deployed at the same site) can perform resource coordination on behalf of a third RAN node that is not co-located with the first and second RAN node but using the same frequency band. For example, a first network node (that is collocated with the second network node) connected to a third network node, can coordinate the shared resources with second network node, in such a way that the second and third network nodes shares the same spectrum with minimal interference level. An embodiment of this aspect is shown in the method illustrated in FIG. 11. Method 1100 is a method performed by a first network node co-located with a second network node for performing resource coordination for a third network node that is not co-located with, but is using the same frequency band as, the first network node or second network node. Step 1110 is configuring a neighbour relation for a second cell served by the second network node. Step 1120 is setting the attribute of the neighbour relation. Step 1130 is determining at least one service to be used over an established interface between the first and second RAN nodes. Step 1140 is indicating the neighbour relation and the at least one attribute to the second network node. Step 1150 is receiving an acknowledgement or rejection of the neighbour relation or the at last one attribute from the second network node. Step 1160 is coordinating one or more resources with the second network node such that neighbouring cells between the first network node and the third network node can coexist on a shared channel. In a sub-embodiment, the first RAN node is an LTE eNB and the second and third network nodes are gNBs connected by an Xn interface. Note that RAN node 1 and RAN node 2 preferably ensure that the RAN node 3 is not interfering with them on co-channel cells.

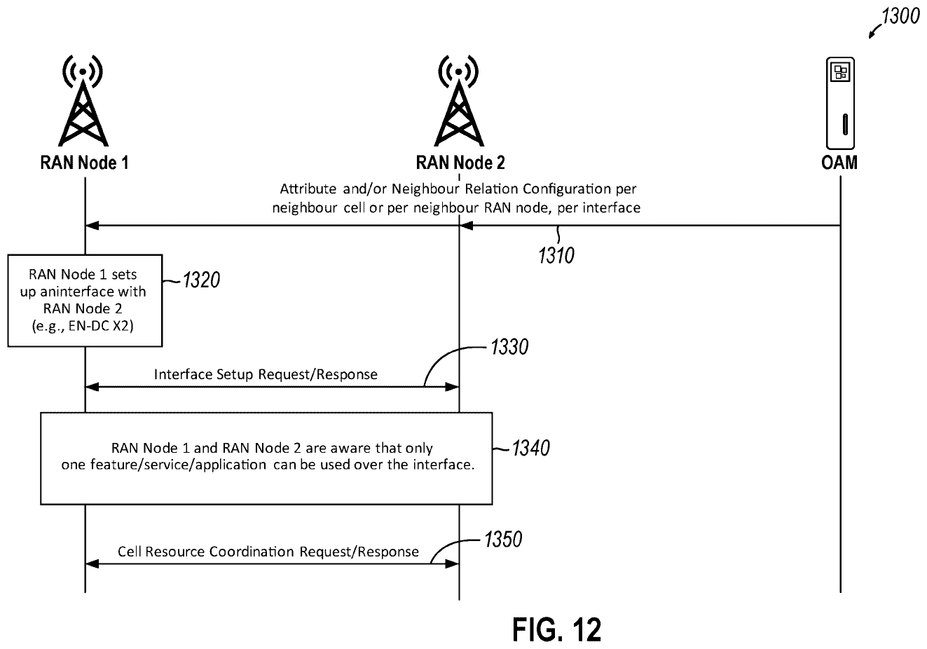

In another embodiment, method 1300 shown in FIG. 12, an OAM (Operation, Administration, Maintenance) can configure attributes for resource coordination between two nodes. At step 1310, the OAM configures the attribute for the “resource coordination only” usage for an interface between the two nodes. At step 1320, the first network node decides, prodded by the OAM, to establish an interface with the second network node, e.g., an EN-DC X2 interface. At step 1330, the interface is established. At step 1340, the network nodes determined (via the attribute configuration from the OAM) that only one feature, e.g., E-UTRA-NR Cell Resource Coordination, can be used over the interface. At step 1350, the two nodes coordinate resource utilization between any of their neighbour cells without having to support all other features enabled by the EN-DC X2 interface.

It is worth noting that the configuration from step 1310 may be provided:
1. on a per neighbour node basis (e.g., configuration valid for all the interfaces established with a given neighbour node);
2. on a per neighbour cell basis (e.g., configuration valid for all the interfaces established with a neighbour node serving a given neighbour cell);
3. on a per interface basis (e.g., configuration valid for a specific interface established with one or more specific neighbour node; or
4. A combination of the above.

In some embodiments or variations of method 1300, one node may have a first cell that is an E-UTRA cell. The other node may have a second cell (neighbouring the first cell) that is an NR cell. Or it could be vice versa. The EN-DC X2 interface can allow these cells to coordinate resources. “Resource Coordination Only,” for example, which can be an attribute in the NCRT. When checked, the neighbour relation between the first and second cells shall use the X2 interface only to coordinate resources (e.g., Resource Coordination; dynamic Spectrum Sharing; PRACH resource coordination) between each other. In some embodiments, the neighbouring cells could be on the same network or RAN node. Or they could share the same gNB in a split architecture.

In some embodiments, the configuration does not need to be provided to both nodes but it could be provided to a first node. In this case, attempts from the second node to use a feature not allowed by the configured attributes may result into failures of the procedures associated with that feature. Specific cause values may be provided in the failure messages to allow the first node to understand that the feature is not allowed to be used.

### Signaling of the Configuration Among Nodes

Signaling of the configuration among the network or RAN nodes can now be described. Upon establishing a cell-to-cell neighbour relation and a network interface between nodes, the first network node indicates to the second network node the determined attributes as part of the NCRT e.g., a set of the features/services/applications to be running over the associated interface.

In one embodiment the interface can be EN-DC X2 interface or in general MR-DC Xn interface or an NG interface. In a non-limiting example, the signal converting the attributes can be X2 Setup or Xn Setup or NG RAN Node Configuration Update according to 3GPP specifications TS 36.423 or TS 38.423. In another example the nodes do not signal the attributes one to the other, but rely on configuration to know which attributes the other node has been configured with. Alternatively, the nodes may not signal the attribute one to the other but they may learn with time what are the features supported by the neighbour node, e.g. by means of failed procedures.

### Example Implementation

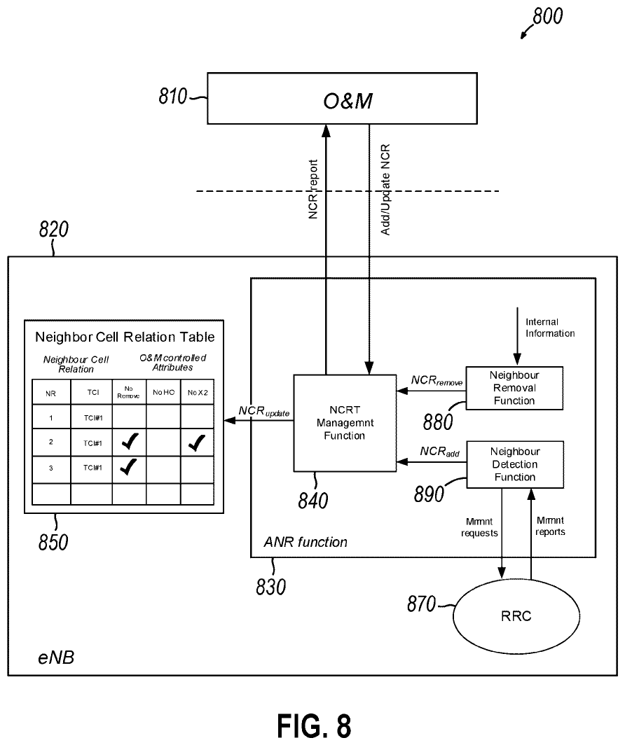

One non-limiting example implementation of a proposed embodiment under the present disclosure is shown as part of 3GPP TS 36.300 and 38.300 respectively as described below and in FIG. 8. System 800 comprises an O&M 810 in communication with eNB 820. eNB 820 comprises NCRT 850 and ANR function 830. The ANR function 830 resides in the eNB 820 and manages the conceptual NCRT 850. ANR function 840 comprises NCRT Management Function 840, Neighbor Removal Function 880 and Neighbour Detection Function 890. ANR function 830 contains the Neighbour Removal Function 880 which removes outdated NCRs. Located within ANR function 830, the Neighbour Detection Function 890 finds new neighbours and adds them to the NCRT 850. The Neighbour Detection Function 890 and the Neighbour Removal Function 880 are implementation specific. The NCRT Management Function 840 can take the information it receives and update the NCRT 850. NCRT Management Function 840 can send NCR reports to the O&M 810 and receive additions or other updates to NCRs. One aspect of the ANR function 830 is to relieve the operator from the burden of manually managing NCRs.

An NCR embodiment in the context of an ANR function such as shown in FIG. 8 can be illustrated as follows. An existing Neighbour Relation from a source cell to a target cell means that an eNB controlling the source cell:
1. Knows the ECGI/CGI and PCI of the target cell;
2. Has an entry in the NCRT for the source cell identifying the target cell;
3. Has the attributes in this NCRT entry defined, either by O&M or set to default values.

For each cell that the eNB has, the eNB keeps a NCRT, such as in FIG. 8. For each NCR, the NCRT contains the TCI, which identifies the target cell. For E-UTRAN, the TCI corresponds to the ECGI and PCI of the target cell. Furthermore, each NCR has some attributes. The attributes can have e.g., the following definitions:
1. No Remove: If checked, the eNB shall not remove the NCR from the NCRT;
2. No HO: If checked, the NCR shall not be used by the eNB for handover reasons;
3. No X2: If checked, the Neighbour Relation shall not use an X2 interface in order to initiate procedures towards the eNB parenting the target cell;
4. Only Resource Coordination: if checked, the Neighbour Relation shall use an X2 interface only in order to coordinate resources between source and the target cell;
5. Only Dynamic Spectrum Sharing: if checked, the Neighbour Relation shall use an X2 interface only dynamic spectrum sharing with the target cell;
6. Only PRACH Resource Coordination: if checked, the Neighbour Relation shall use an X2 interface only in order to coordinate PRACH resources and resolve potential PRACH conflicts between source and target RAN node.

NCRs are cell-to-cell relations, while an X2 link is set up between two eNBs. NCRs are unidirectional, while an X2 link is bidirectional. The neighbour information exchange, which occurs during the X2 Setup procedure or in the eNB Configuration Update procedure, may be used for ANR function purposes. The ANR function also allows O&M to manage the NCRT. O&M can add and delete NCRs. It can also change the attributes of the NCRT. The O&M system is informed about changes in the NCRT.

### ANR Function Towards NR

ANR Function towards NR can also be described. The ANR function described in relation to FIG. 8 can be applied towards NR with enhancements. An existing NCR from a source E-UTRA cell to a target NR cell means that the eNB controlling the source cell knows the NCGI and PCI of the target cell. If an NCR from a source E-UTRA cell to a target E-UTRA cell exists, the eNB controlling the source cell has information whether the target E-UTRA cell has an existing NCR to a target NR cell for performing EN-DC. An X2 link may be set up between eNB and en-gNB. The NoRemove, the NoHO and the NoX2 attributes apply when the en-gNB parents the target cell. NCRs can have the following additional attributes:
1. No EN-DC: If checked, the NCR shall not be used by the eNB for EN-DC;
2. Only Resource Coordination: if checked, the Neighbour Relation shall use an X2 interface only in order to coordinate resources between source and the target cell;
3. Only Dynamic Spectrum Sharing: if checked, the Neighbour Relation shall use an X2 interface only in order to coordinate dynamic spectrum sharing with the target cell; or
4. Only PRACH Resource Coordination: if checked, the Neighbour Relation shall use an X2 interface only in order to coordinate PRACH resources and resolve potential PRACH conflicts between source and target RAN node.

Each E-UTRA cell contains an Inter Frequency Search list. This list contains all frequencies that can be searched. The PCI is defined by the frequency of the SSB (Synchronization Signal Block) associated with SIB1 (System Information Block 1), and NR-PCI.

In yet another non-limiting example the solution can be implemented in the 3GPP TS 38.300, as shown in the following description of application layer initialization.

### Application Layer Initialization

Once SCTP connectivity has been established, the NG-RAN node and its candidate peer NG-RAN node are in a position to exchange application level configuration data over XnAP needed for the two nodes to interwork correctly on the Xn interface.
The NG-RAN node provides the relevant configuration information to the candidate NG-RAN node, which includes served cell information;
The candidate NG-RAN node provides the relevant configuration information to the initiating NG-RAN node, which includes served cell information;
When the application layer initialization is successfully concluded, the dynamic configuration procedure is completed and the Xn interface is operational;
The NG-RAN node shall keep neighbouring NG-RAN nodes updated with the complete list of served cells, or, if requested by the peer NG-RAN node, by a limited list of served cells, while the Xn interface is operational.

### Automatic Neighbour Cell Relation Function

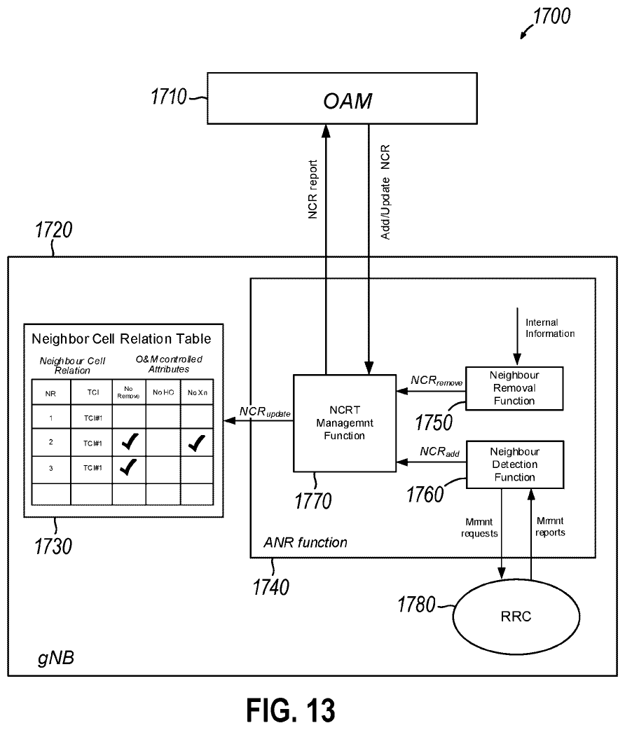

Further description can now be given of Automatic Neighbour Cell Relation Function. One purpose of the ANR function is to relieve the operator from the burden of manually managing NCRs. FIG. 13 shows another example ANR and its environment in a system 1700.

System 1700 comprises an OAM 1710 and gNB 1720. The ANR function 1740 resides in gNB 1720 and manages the NCRT 1730. Located within ANR function 1740, the Neighbour Detection Function 1760 is communicatively coupled to RRC 1780 and finds new neighbours and adds them to the NCRT 1730 via NCRT Management Function 1770. ANR function 1740 also contains the Neighbour Removal Function 1750 which removes outdated NCRs via NCRT Management Function 1770. The Neighbour Detection Function 1760 and the Neighbour Removal Function 1750 are implementation specific. The ANR function 1740 also allows OAM 1710 to manage the NCRT 1730. OAM 1710 can add and delete NCRs. It can also change the attributes of the NCRT 1730. The OAM 1710 is informed about changes in the NCRT 1730.

An existing NCR from a source cell to a target cell means that a gNB controlling the source cell:
1. Knows the global and physical IDs (e.g., NR CGI/NR PCI, ECGI/PCI) of the target cell;
2. Has an entry in the NCRT for the source cell identifying the target cell; and
3. Has the attributes in this NCRT entry defined, either by OAM or set to default values.

NCRs are cell-to-cell relations, while an Xn link is set up between two gNBs. NCRs are unidirectional, while an Xn link is bidirectional. The neighbour information exchange, which occurs during the Xn Setup procedure or in the gNB Configuration Update procedure, may be used for ANR purposes.

Furthermore, each NCR can have some attributes. The attributes can have the following definitions:
1. Only Resource Coordination: if checked, the neighbour relation shall use an X2 interface only in order to coordinate resources between source and the target cell;
2. Only Dynamic Spectrum Sharing: if checked, the neighbour relation shall use an X2 interface only for dynamic spectrum sharing with the target cell;
3. Only PRACH Resource Coordination: if checked, the neighbour relation shall use an X2 interface only in order to coordinate PRACH resources and resolve potential PRACH conflicts between source and target RAN node.

### Intra-System Automatic Neighbour Cell Relation Function

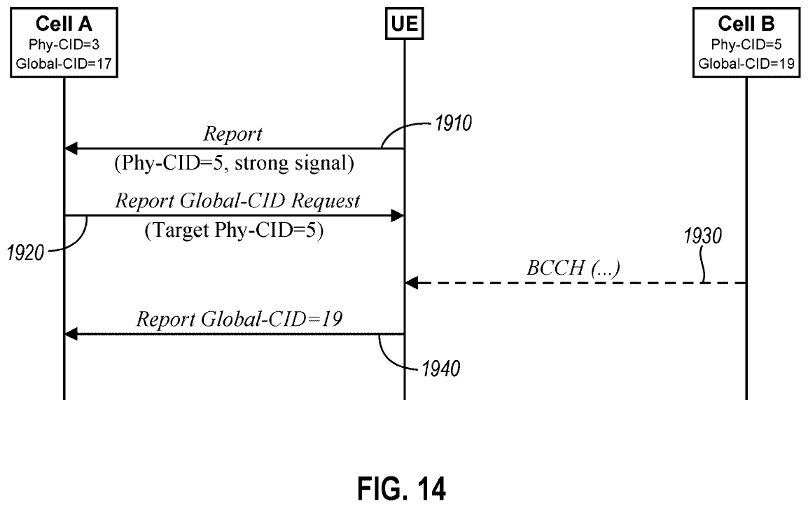

An intra-system Automatic Neighbour Cell Relation Function can be implemented as well. Several examples can help to describe such implementations. ANR relies on NCGI and ANR reporting of E-UTRA cells as specified in TS 36.300. FIG. 14 depicts an example where the NG-RAN node serving cell A has an ANR function. In RRC_CONNECTED, the NG-RAN node instructs each UE to perform measurements on neighbour cells. The NG-RAN node may use different policies for instructing the UE to do measurements, and when to report them to the NG-RAN node. This measurement procedure is as specified in TS 38.331 and TS 36.331. At step 1910, the UE sends a measurement report regarding cell B. This report contains Cell B's PCI, but not its NCGI/ECGI. When the NG-RAN node receives a UE measurement report containing the PCI, the following sequence may be used. At 1920, the NG-RAN node request the UE, using the newly discovered PCI as parameter, to read all the broadcast NCGIs/ECGIs, TACs, RANACs (RAN area codes), PLMN IDs and, for neighbour NR cells, NR frequency bands. To do so, the NG-RAN node may need to schedule appropriate idle periods to allow the UE to read the NCGI/ECGI from the broadcast channel of the detected neighbour cell, step 1920. How the UE reads the NCGI/ECGI is specified in TS 38.331 and TS 36.331. When the UE has found out the new cell's NCGIs/ECGIs, the UE reports all the broadcast NCGIs/ECGIs to the serving cell NG-RAN node, at 1940. In addition, the UE reports all the tracking area codes, RANACs, PLMN IDs and, for neighbour NR cells, NR frequency bands, that have been read by the UE. In case the detected NR cell does not broadcast SIB1, the UE may report noSIB1 indication as specified in TS 38.331. In possible embodiments, the NG-RAN node of cell A can perform additional steps. In some embodiments the NG-RAN node decides to add this neighbour relation, and can use PCI and NCGIs/ECGIs to:
1. Lookup a transport layer address to the new NG-RAN node;
2. Update the NCR List;
3. If needed, setup a new Xn interface towards this NG-RAN node.

Furthermore, each inter system NCR can have some attributes. The attributes can have the following definitions:
1. Only Resource Coordination: if checked, the neighbour relation shall use an X2 interface only in order to coordinate resources between source and the target cell;
2. Only Dynamic Spectrum Sharing: if checked, the neighbour relation shall use an X2 interface only dynamic spectrum sharing with the target cell;
3. Only PRACH Resource Coordination: if checked, the neighbour relation shall use an X2 interface only in order to coordinate PRACH resources and resolve potential PRACH conflicts between source and target RAN node.

### Additional Embodiments

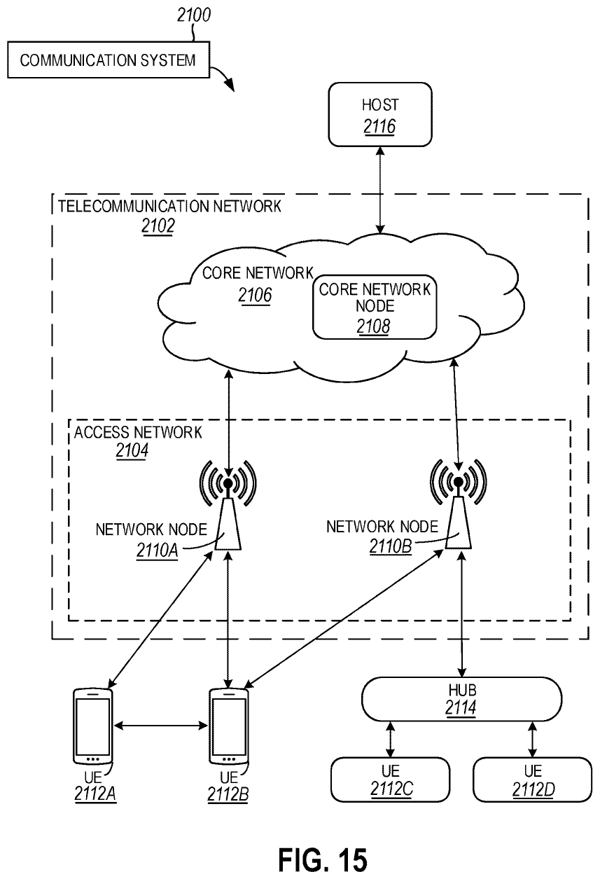

FIG. 15 shows an example of a communication system 2100 in accordance with some embodiments. In the example, the communication system 2100 includes a telecommunication network 2102 that includes an access network 2104, such as a RAN, and a core network 2106, which includes one or more core network nodes 2108. The access network 2104 includes one or more access network nodes, such as network nodes 2110a and 2110b (one or more of which may be generally referred to as network nodes 2110), or any other similar 3rd Generation Partnership Project (3GPP) access node or non-3GPP access point. The network nodes 2110 facilitate direct or indirect connection of UE, such as by connecting UEs 2112a, 2112b, 2112c, and 2112d (one or more of which may be generally referred to as UEs 2112) to the core network 2106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 2100 may include and/or interface with any type of communication, telecommunication, data, cellular, radio network, and/or other similar type of system.

The UEs 2112 may be any of a wide variety of communication devices, including wireless devices arranged, configured, and/or operable to communicate wirelessly with the network nodes 2110 and other communication devices. Similarly, the network nodes 2110 are arranged, capable, configured, and/or operable to communicate directly or indirectly with the UEs 2112 and/or with other network nodes or equipment in the telecommunication network 2102 to enable and/or provide network access, such as wireless network access, and/or to perform other functions, such as administration in the telecommunication network 2102.

In the depicted example, the core network 2106 connects the network nodes 2110 to one or more hosts, such as host 2116. These connections may be direct or indirect via one or more intermediary networks or devices. In other examples, network nodes may be directly coupled to hosts. The core network 2106 includes one more core network nodes (e.g., core network node 2108) that are structured with hardware and software components. Features of these components may be substantially similar to those described with respect to the UEs, network nodes, and/or hosts, such that the descriptions thereof are generally applicable to the corresponding components of the core network node 2108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2116 may be under the ownership or control of a service provider other than an operator or provider of the access network 2104 and/or the telecommunication network 2102, and may be operated by the service provider or on behalf of the service provider. The host 2116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2100 of FIG. 15 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2102 is a cellular network that implements 3GPP standardized features. Accordingly, the telecommunications network 2102 may support network slicing to provide different logical networks to different devices that are connected to the telecommunication network 2102. For example, the telecommunications network 2102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2112 are configured to transmit and/or receive information without direct human interaction. For instance, a UE may be designed to transmit information to the access network 2104 on a predetermined schedule, when triggered by an internal or external event, or in response to requests from the access network 2104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2114 communicates with the access network 2104 to facilitate indirect communication between one or more UEs (e.g., UE 2112c and/or 2112d) and network nodes (e.g., network node 2110b). In some examples, the hub 2114 may be a controller, router, content source and analytics, or any of the other communication devices described herein regarding UEs. For example, the hub 2114 may be a broadband router enabling access to the core network 2106 for the UEs. As another example, the hub 2114 may be a controller that sends commands or instructions to one or more actuators in the UEs. Commands or instructions may be received from the UEs, network nodes 2110, or by executable code, script, process, or other instructions in the hub 2114. As another example, the hub 2114 may be a data collector that acts as temporary storage for UE data and, in some embodiments, may perform analysis or other processing of the data. As another example, the hub 2114 may be a content source. For example, for a UE that is a VR headset, display, loudspeaker or other media delivery device, the hub 2114 may retrieve VR assets, video, audio, or other media or data related to sensory information via a network node, which the hub 2114 then provides to the UE either directly, after performing local processing, and/or after adding additional local content. In still another example, the hub 2114 acts as a proxy server or orchestrator for the UEs, in particular in if one or more of the UEs are low energy IoT devices.

The hub 2114 may have a constant/persistent or intermittent connection to the network node 2110b. The hub 2114 may also allow for a different communication scheme and/or schedule between the hub 2114 and UEs (e.g., UE 2112c and/or 2112d), and between the hub 2114 and the core network 2106. In other examples, the hub 2114 is connected to the core network 2106 and/or one or more UEs via a wired connection. Moreover, the hub 2114 may be configured to connect to an M2M service provider over the access network 1104 and/or to another UE over a direct connection. In some scenarios, UEs may establish a wireless connection with the network nodes 2110 while still connected via the hub 2114 via a wired or wireless connection. In some embodiments, the hub 2114 may be a dedicated hub—that is, a hub whose primary function is to route communications to/from the UEs from/to the network node 2110b. In other embodiments, the hub 2114 may be a non-dedicated hub—that is, a device which is capable of operating to route communications between the UEs and network node 2110b, but which is additionally capable of operating as a communication start and/or end point for certain data channels.

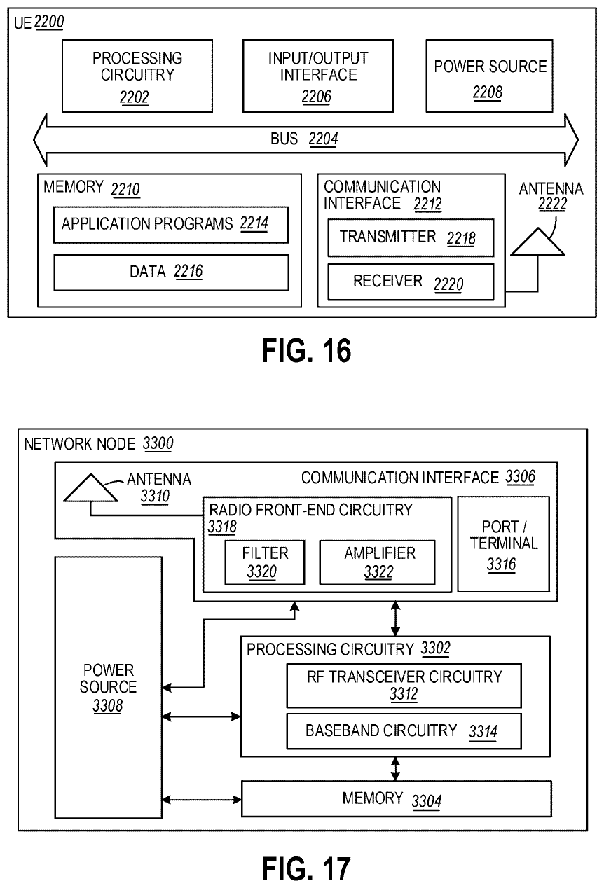

FIG. 16 shows a UE 2200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2200 includes processing circuitry 2202 that is operatively coupled via a bus 2204 to an input/output interface 2206, a power source 2208, a memory 2210, a communication interface 2212, and/or any other component, or any combination thereof. Certain UEs may utilize all or a subset of the components shown in FIG. 16. The level of integration between the components may vary from one UE to another UE. Further, certain UEs may contain multiple instances of a component, such as multiple processors, memories, transceivers, transmitters, receivers, etc.

The processing circuitry 2202 is configured to process instructions and data and may be configured to implement any sequential state machine operative to execute instructions stored as machine-readable computer programs in the memory 2210. The processing circuitry 2202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2202 may include multiple central processing units (CPUs).

In the example, the input/output interface 2206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2208 is structured as a battery or battery pack. Other types of power sources, such as an external power source (e.g., an electricity outlet), photovoltaic device, or power cell, may be used. The power source 2208 may further include power circuitry for delivering power from the power source 2208 itself, and/or an external power source, to the various parts of the UE 2200 via input circuitry or an interface such as an electrical power cable. Delivering power may be, for example, for charging of the power source 2208. Power circuitry may perform any formatting, converting, or other modification to the power from the power source 2208 to make the power suitable for the respective components of the UE 2200 to which power is supplied.

The memory 2210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2210 includes one or more application programs 2214, such as an operating system, web browser application, a widget, gadget engine, or other application, and corresponding data 2216. The memory 2210 may store, for use by the UE 2200, any of a variety of various operating systems or combinations of operating systems.

The memory 2210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2210 may allow the UE 2200 to access instructions, application programs and the like, stored on transitory or non-transitory memory media, to off-load data, or to upload data. An article of manufacture, such as one utilizing a communication system may be tangibly embodied as or in the memory 2210, which may be or comprise a device-readable storage medium.

The processing circuitry 2202 may be configured to communicate with an access network or other network using the communication interface 2212. The communication interface 2212 may comprise one or more communication subsystems and may include or be communicatively coupled to an antenna 2222. The communication interface 2212 may include one or more transceivers used to communicate, such as by communicating with one or more remote transceivers of another device capable of wireless communication (e.g., another UE or a network node in an access network). Each transceiver may include a transmitter 2218 and/or a receiver 2220 appropriate to provide network communications (e.g., optical, electrical, frequency allocations, and so forth). Moreover, the transmitter 2218 and receiver 2220 may be coupled to one or more antennas (e.g., antenna 2222) and may share circuit components, software or firmware, or alternatively be implemented separately.

In the illustrated embodiment, communication functions of the communication interface 2212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2200 shown in FIG. 16.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 17 shows a network node 3300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3300 includes a processing circuitry 3302, a memory 3304, a communication interface 3306, and a power source 3308. The network node 3300 may be composed of multiple physically separate components (e.g., a NodeB component and a RNC component, or a BTS component and a BSC component, etc.), which may each have their own respective components. In certain scenarios in which the network node 3300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 3304 for different RATs) and some components may be reused (e.g., a same antenna 3310 may be shared by different RATs). The network node 3300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 3302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3300 components, such as the memory 3304, to provide network node 3300 functionality.

In some embodiments, the processing circuitry 3302 includes a system on a chip (SOC). In some embodiments, the processing circuitry 3302 includes one or more of radio frequency (RF) transceiver circuitry 3312 and baseband processing circuitry 3314. In some embodiments, the radio frequency (RF) transceiver circuitry 3312 and the baseband processing circuitry 3314 may be on separate chips (or sets of chips), boards, or units, such as radio units and digital units. In alternative embodiments, part or all of RF transceiver circuitry 3312 and baseband processing circuitry 3314 may be on the same chip or set of chips, boards, or units.

The memory 3304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3302. The memory 3304 may store any suitable instructions, data, or information, including a computer program, software, an application including one or more of logic, rules, code, tables, and/or other instructions capable of being executed by the processing circuitry 3302 and utilized by the network node 3300. The memory 3304 may be used to store any calculations made by the processing circuitry 3302 and/or any data received via the communication interface 3306. In some embodiments, the processing circuitry 3302 and memory 3304 is integrated.

The communication interface 3306 is used in wired or wireless communication of signaling and/or data between a network node, access network, and/or UE. As illustrated, the communication interface 3306 comprises port(s)/terminal(s) 3316 to send and receive data, for example to and from a network over a wired connection. The communication interface 3306 also includes radio front-end circuitry 3318 that may be coupled to, or in certain embodiments a part of, the antenna 3310. Radio front-end circuitry 3318 comprises filters 3320 and amplifiers 3322. The radio front-end circuitry 3318 may be connected to an antenna 3310 and processing circuitry 3302. The radio front-end circuitry may be configured to condition signals communicated between antenna 3310 and processing circuitry 3302. The radio front-end circuitry 3318 may receive digital data that is to be sent out to other network nodes or UEs via a wireless connection. The radio front-end circuitry 3318 may convert the digital data into a radio signal having the appropriate channel and bandwidth parameters using a combination of filters 3320 and/or amplifiers 3322. The radio signal may then be transmitted via the antenna 3310. Similarly, when receiving data, the antenna 3310 may collect radio signals which are then converted into digital data by the radio front-end circuitry 3318. The digital data may be passed to the processing circuitry 3302. In other embodiments, the communication interface may comprise different components and/or different combinations of components.

In certain alternative embodiments, the network node 3300 does not include separate radio front-end circuitry 3318, instead, the processing circuitry 3302 includes radio front-end circuitry and is connected to the antenna 3310. Similarly, in some embodiments, all or some of the RF transceiver circuitry 3312 is part of the communication interface 3306. In still other embodiments, the communication interface 3306 includes one or more ports or terminals 3316, the radio front-end circuitry 3318, and the RF transceiver circuitry 3312, as part of a radio unit (not shown), and the communication interface 3306 communicates with the baseband processing circuitry 3314, which is part of a digital unit (not shown).

The antenna 3310 may include one or more antennas, or antenna arrays, configured to send and/or receive wireless signals. The antenna 3310 may be coupled to the radio front-end circuitry 3318 and may be any type of antenna capable of transmitting and receiving data and/or signals wirelessly. In certain embodiments, the antenna 3310 is separate from the network node 3300 and connectable to the network node 3300 through an interface or port.

The antenna 3310, communication interface 3306, and/or the processing circuitry 3302 may be configured to perform any receiving operations and/or certain obtaining operations described herein as being performed by the network node. Any information, data and/or signals may be received from a UE, another network node and/or any other network equipment. Similarly, the antenna 3310, the communication interface 3306, and/or the processing circuitry 3302 may be configured to perform any transmitting operations described herein as being performed by the network node. Any information, data and/or signals may be transmitted to a UE, another network node and/or any other network equipment.

The power source 3308 provides power to the various components of network node 3300 in a form suitable for the respective components (e.g., at a voltage and current level needed for each respective component). The power source 3308 may further comprise, or be coupled to, power management circuitry to supply the components of the network node 3300 with power for performing the functionality described herein. For example, the network node 3300 may be connectable to an external power source (e.g., the power grid, an electricity outlet) via an input circuitry or interface such as an electrical cable, whereby the external power source supplies power to power circuitry of the power source 3308. As a further example, the power source 3308 may comprise a source of power in the form of a battery or battery pack which is connected to, or integrated in, power circuitry. The battery may provide backup power should the external power source fail.

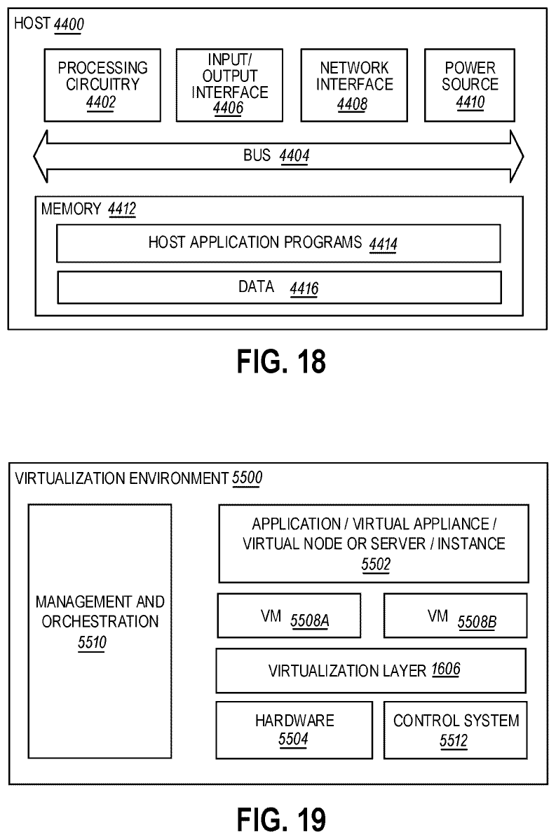

Embodiments of the network node 3300 may include additional components beyond those shown in FIG. 18 for providing certain aspects of the network node's functionality, including any of the functionality described herein and/or any functionality necessary to support the subject matter described herein. For example, the network node 3300 may include user interface equipment to allow input of information into the network node 3300 and to allow output of information from the network node 3300. This may allow a user to perform diagnostic, maintenance, repair, and other administrative functions for the network node 3300.

FIG. 18 is a block diagram of a host 4400, which may be an embodiment of the host 2116 of FIG. 15, in accordance with various aspects described herein. As used herein, the host 4400 may be or comprise various combinations hardware and/or software, including a standalone server, a blade server, a cloud-implemented server, a distributed server, a virtual machine, container, or processing resources in a server farm. The host 4400 may provide one or more services to one or more UEs.

The host 4400 includes processing circuitry 4402 that is operatively coupled via a bus 4404 to an input/output interface 4406, a network interface 4408, a power source 4410, and a memory 4412. Other components may be included in other embodiments. Features of these components may be substantially similar to those described with respect to the devices of previous figures, such as FIGS. 17 and 18, such that the descriptions thereof are generally applicable to the corresponding components of host 4400.

The memory 4412 may include one or more computer programs including one or more host application programs 4414 and data 4416, which may include user data, e.g., data generated by a UE for the host 4400 or data generated by the host 4400 for a UE. Embodiments of the host 4400 may utilize only a subset or all of the components shown. The host application programs 4414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 4414 may also provide for user authentication and licensing checks and may periodically report health, routes, and content availability to a central node, such as a device in or on the edge of a core network. Accordingly, the host 4400 may select and/or indicate a different host for over-the-top services for a UE. The host application programs 4414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 19 is a block diagram illustrating a virtualization environment 5500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 5500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 5502 (which may alternatively be called software instances, virtual appliances, network functions, virtual nodes, virtual network functions, etc.) are run in the virtualization environment 5500 to implement some of the features, functions, and/or benefits of some of the embodiments disclosed herein.

Hardware 5504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 5506 (also referred to as hypervisors or virtual machine monitors (VMMs)), provide VMs 5508a and 5508b (one or more of which may be generally referred to as VMs 5508), and/or perform any of the functions, features and/or benefits described in relation with some embodiments described herein. The virtualization layer 5506 may present a virtual operating platform that appears like networking hardware to the VMs 5508.

The VMs 5508 comprise virtual processing, virtual memory, virtual networking or interface and virtual storage, and may be run by a corresponding virtualization layer 5506. Different embodiments of the instance of a virtual appliance 5502 may be implemented on one or more of VMs 5508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 5508 may be a software implementation of a physical machine that runs programs as if they were executing on a physical, non-virtualized machine. Each of the VMs 5508, and that part of hardware 5504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 5508 on top of the hardware 5504 and corresponds to the application 5502.

Hardware 5504 may be implemented in a standalone network node with generic or specific components. Hardware 5504 may implement some functions via virtualization. Alternatively, hardware 5504 may be part of a larger cluster of hardware (e.g., such as in a data center or CPE) where many hardware nodes work together and are managed via management and orchestration 5510, which, among others, oversees lifecycle management of applications 5502. In some embodiments, hardware 5504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 5512 which may alternatively be used for communication between hardware nodes and radio units.

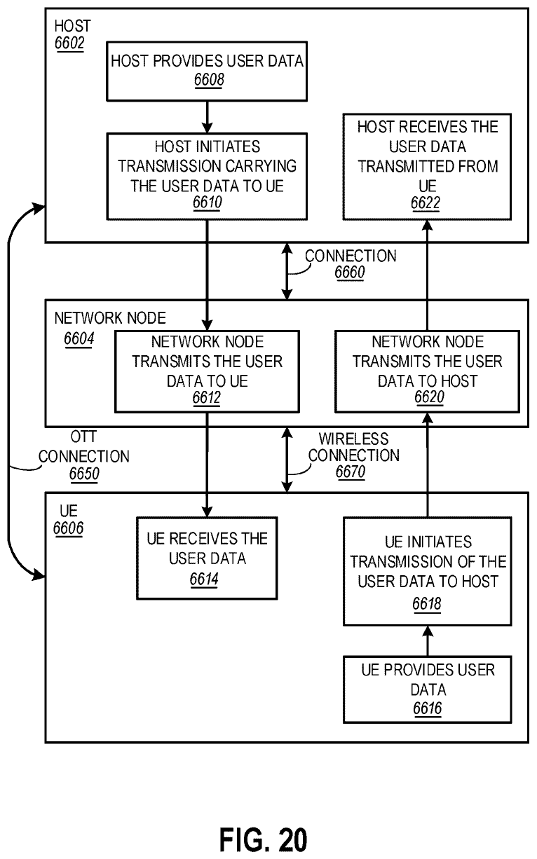

FIG. 20 shows a communication diagram of a host 6602 communicating via a network node 6604 with a UE 6606 over a partially wireless connection in accordance with some embodiments. Example implementations, in accordance with various embodiments, of the UE (such as a UE 2112a of FIG. 15 and/or UE 2200 of FIG. 16), network node (such as network node 2110a of FIG. 15 and/or network node 3300 of FIG. 17), and host (such as host 2116 of FIG. 15 and/or host 4400 of FIG. 18) discussed in the preceding paragraphs will now be described with reference to FIG. 20.

Like host 4400, embodiments of host 6602 include hardware, such as a communication interface, processing circuitry, and memory. The host 6602 also includes software, which is stored in or accessible by the host 6602 and executable by the processing circuitry. The software includes a host application that may be operable to provide a service to a remote user, such as the UE 6606 connecting via an over-the-top (OTT) connection 6650 extending between the UE 6606 and host 6602. In providing the service to the remote user, a host application may provide user data which is transmitted using the OTT connection 6650.

The network node 6604 includes hardware enabling it to communicate with the host 6602 and UE 6606. The connection 6660 may be direct or pass through a core network (like core network 2106 of FIG. 15) and/or one or more other intermediate networks, such as one or more public, private, or hosted networks. For example, an intermediate network may be a backbone network or the Internet.

The UE 6606 includes hardware and software, which is stored in or accessible by UE 6606 and executable by the UE's processing circuitry. The software includes a client application, such as a web browser or operator-specific “app” that may be operable to provide a service to a human or non-human user via UE 6606 with the support of the host 6602. In the host 6602, an executing host application may communicate with the executing client application via the OTT connection 6650 terminating at the UE 6606 and host 6602. In providing the service to the user, the UE's client application may receive request data from the host's host application and provide user data in response to the request data. The OTT connection 6650 may transfer both the request data and the user data. The UE's client application may interact with the user to generate the user data that it provides to the host application through the OTT connection 6650.

The OTT connection 6650 may extend via a connection 6660 between the host 6602 and the network node 6604 and via a wireless connection 6670 between the network node 6604 and the UE 6606 to provide the connection between the host 6602 and the UE 6606. The connection 6660 and wireless connection 6670, over which the OTT connection 6650 may be provided, have been drawn abstractly to illustrate the communication between the host 6602 and the UE 1606 via the network node 6604, without explicit reference to any intermediary devices and the precise routing of messages via these devices.

As an example of transmitting data via the OTT connection 6650, in step 6608, the host 6602 provides user data, which may be performed by executing a host application. In some embodiments, the user data is associated with a particular human user interacting with the UE 6606. In other embodiments, the user data is associated with a UE 6606 that shares data with the host 6602 without explicit human interaction. In step 6610, the host 6602 initiates a transmission carrying the user data towards the UE 6606. The host 6602 may initiate the transmission responsive to a request transmitted by the UE 6606. The request may be caused by human interaction with the UE 6606 or by operation of the client application executing on the UE 6606. The transmission may pass via the network node 6604, in accordance with the teachings of the embodiments described throughout this disclosure. Accordingly, in step 6612, the network node 6604 transmits to the UE 6606 the user data that was carried in the transmission that the host 6602 initiated, in accordance with the teachings of the embodiments described throughout this disclosure. In step 6614, the UE 6606 receives the user data carried in the transmission, which may be performed by a client application executed on the UE 6606 associated with the host application executed by the host 6602.

In some examples, the UE 6606 executes a client application which provides user data to the host 6602. The user data may be provided in reaction or response to the data received from the host 6602. Accordingly, in step 6616, the UE 6606 may provide user data, which may be performed by executing the client application. In providing the user data, the client application may further consider user input received from the user via an input/output interface of the UE 6606. Regardless of the specific manner in which the user data was provided, the UE 6606 initiates, in step 6618, transmission of the user data towards the host 6602 via the network node 6604. In step 6620, in accordance with the teachings of the embodiments described throughout this disclosure, the network node 6604 receives user data from the UE 6606 and initiates transmission of the received user data towards the host 6602. In step 6622, the host 6602 receives the user data carried in the transmission initiated by the UE 6606.

One or more of the various embodiments improve the performance of OTT services provided to the UE 6606 using the OTT connection 6650, in which the wireless connection 6670 forms the last segment. More precisely, the teachings of these embodiments may improve the data rate, latency, and/or power consumption and thereby provide benefits such as reduced user waiting time, relaxed restriction on file size, improved content resolution, better responsiveness, and/or extended battery lifetime.

In an example scenario, factory status information may be collected and analyzed by the host 6602. As another example, the host 6602 may process audio and video data which may have been retrieved from a UE for use in creating maps. As another example, the host 6602 may collect and analyze real-time data to assist in controlling vehicle congestion (e.g., controlling traffic lights). As another example, the host 6602 may store surveillance video uploaded by a UE. As another example, the host 6602 may store or control access to media content such as video, audio, VR or AR which it can broadcast, multicast or unicast to UEs. As other examples, the host 6602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 6650 between the host 6602 and UE 6606, in response to variations in the measurement results. The measurement procedure and/or the network functionality for reconfiguring the OTT connection may be implemented in software and hardware of the host 6602 and/or UE 6606. In some embodiments, sensors (not shown) may be deployed in or in association with other devices through which the OTT connection 6650 passes; the sensors may participate in the measurement procedure by supplying values of the monitored quantities exemplified above, or supplying values of other physical quantities from which software may compute or estimate the monitored quantities. The reconfiguring of the OTT connection 6650 may include message format, retransmission settings, preferred routing etc.; the reconfiguring need not directly alter the operation of the network node 6604. Such procedures and functionalities may be known and practiced in the art. In certain embodiments, measurements may involve proprietary UE signaling that facilitates measurements of throughput, propagation times, latency and the like, by the host 6602. The measurements may be implemented in that software causes messages to be transmitted, in particular empty or ‘dummy’ messages, using the OTT connection 6650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Computer Systems of the Present Disclosure

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The memory may take any form and may depend on the nature and form of the computing system. The memory can be physical system memory, which includes volatile memory, non-volatile memory, or some combination of the two. The term “memory” may also be used herein to refer to non-volatile mass storage such as physical storage media.

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof.

For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The term “executable component” is also well understood by one of ordinary skill as including structures that are implemented exclusively or near-exclusively in hardware logic components, such as within a field programmable gate array (FPGA), an application specific integrated circuit (ASIC), Program-specific Standard Products (ASSPs), System-on-a-chip systems (SOCs), Complex Programmable Logic Devices (CPLDs), or any other specialized circuit. Accordingly, the term “executable component” is a term for a structure that is well understood by those of ordinary skill in the art of computing, whether implemented in software, hardware, or a combination thereof.

The terms “component,” “service,” “engine,” “module,” “control,” “generator,” or the like may also be used in this description. As used in this description and in this case, these terms-whether expressed with or without a modifying clause are also intended to be synonymous with the term “executable component” and thus also have a structure that is well understood by those of ordinary skill in the art of computing.

In an embodiment, the communication system may include a complex of computing devices executing any of the method of the embodiments as described above and data storage devices which could be server parks and data centers.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

Accordingly, embodiments described herein may comprise or utilize a special purpose or general-purpose computing system. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example—not limitation—embodiments disclosed or envisioned herein can comprise at least two distinctly different kinds of computer-readable media: storage media and transmission media.

Computer-readable storage media include RAM, ROM, EEPROM, solid state drives (“SSDs”), flash memory, phase-change memory (“PCM”), CD-ROM or other optical disk storage, magnetic disk storage or other magnetic storage devices, or any other physical and tangible storage medium that can be used to store desired program code in the form of computer-executable instructions or data structures and that can be accessed and executed by a general purpose or special purpose computing system to implement the disclosed functionality or functionalities. For example, computer-executable instructions may be embodied on one or more computer-readable storage media to form a computer program product.

Transmission media can include a network and/or data links that can be used to carry desired program code in the form of computer-executable instructions or data structures and that can be accessed and executed by a general purpose or special purpose computing system. Combinations of the above should also be included within the scope of computer-readable media.

Further, upon reaching various computing system components, program code in the form of computer-executable instructions or data structures can be transferred automatically from transmission media to storage media (or vice versa). For example, computer-executable instructions or data structures received over a network or data link can be buffered in RAM within a network interface module (e.g., a “NIC”) and then eventually transferred to computing system RAM and/or to less volatile storage media at a computing system. Thus, it should be understood that storage media can be included in computing system components that also or even primarily-utilize transmission media.

Those skilled in the art will further appreciate that a computing system may also contain communication channels that allow the computing system to communicate with other computing systems over, for example, a network. Accordingly, the methods described herein may be practiced in network computing environments with many types of computing systems and computing system configurations. The disclosed methods may also be practiced in distributed system environments where local and/or remote computing systems, which are linked through a network (either by wired data links, wireless data links, or by a combination of wired and wireless data links), both perform tasks. In a distributed system environment, the processing, memory, and/or storage capability may be distributed as well.

Those skilled in the art will also appreciate that the disclosed methods may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### CONCLUSION

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by preferred embodiments, exemplary embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

All references cited in this application are hereby incorporated in their entireties by reference to the extent that they are not inconsistent with the disclosure in this application. It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

1. A method performed by an Operation, Administration, and Maintenance, OAM, node (3300) for configuring an attribute configuration between a first cell served by a first network node (3300) and a second cell served by a second network node (3300), the method comprising:
configuring (1310) at least one attribute configuration at the first network node and at the second network node, wherein the at least one attribute configuration identifies at least one service to be used over an interface between the first cell and the second cell.

2. The method of claim 1, wherein the at least one service only comprises one service at a time.

3. The method of claim 1, wherein the at least one attribute configuration comprises a portion of at least one neighbour relation configuration.

4. The method of claim 1, wherein the interface is only used for one of the following services: dynamic spectrum sharing; coordinating resources; or coordinating physical random access channel, PRACH, resources and resolving potential PRACH conflicts.

5. The method of claim 1, wherein the first cell comprises an Evolved Universal Terrestrial Radio Access, E-UTRA, cell and the second cell comprises a New Radio, NR, cell.

6. The method of claim 1, wherein the E-UTRA cell comprises a target cell and the NR cell comprises a source cell.

7. The method of claim 1, wherein the E-UTRA cell comprises a source cell and the NR cell comprises a target cell.

8. The method of claim 1, wherein the first node and second node are served by the same NR Node B, gNB.

9. The method of claim 1, wherein the interface comprises an EUTRA-NR Dual Connectivity, EN-DC, X2 interface.

10. The method of claim 1, wherein the at least one attribute configuration comprises one or more of the following options:
No EUTRA-NR Dual Connectivity, EN-DC, wherein a respective neighbour relation shall not be used by a source cell for EN-DC;
Only Resource Coordination, wherein the respective neighbour relation shall use an X2 interface only in order to coordinate resources between the source cell and a target cell;
Only Dynamic Spectrum Sharing, wherein the respective neighbhour relation shall use an X2 interface only in order to coordinate dynamic spectrum sharing from the source cell with the target cell; or
Only physical random access channel, PRACH, Resource Coordination, wherein the respective neighbour relation shall use an X2 interface only in order to coordinate PRACH resources and resolve potential PRACH conflicts between the first network node and the second network node.

11. The method of claim 3, wherein the neighbour relation configuration is configured as part of a Neighbour Cell Relation Table, NCRT.

12. The method of claim 1, wherein the at least one service allows at least one of the following to continue running: interface setup; transport network association maintenance; and configuration updates.

13. A method performed by a first network node for configuring an attribute configuration between a first cell served by the first network node and a second cell served by a second network node, the method comprising:
receiving (1310), from an Operation, Administration, and Maintenance, OAM, at least one attribute configuration, wherein the at least one attribute configuration identifies at least one service to be used over an interface between the first cell and the second cell;
setting up (1330) the interface between the first cell and the second cell; and
using (1350) the at least one service over the interface.

14. The method of claim 13, wherein the interface comprises an EUTRA-NR Dual Connectivity, EN-DC, X2 interface.

15. The method of claim 13, wherein the at least one service comprises one of: only resource coordination; only dynamic spectrum sharing; or only physical random access channel, PRACH, resource coordination.

16. The method of claim 13, wherein the at least one attribute configuration comprises a portion of at least one neighbour relation configuration configured to be stored in a neighbour cell relation table, NCRT.

17. The method of claim 13, wherein the first cell comprises one of: an Evolved Universal Terrestrial Radio Access, E-UTRA, cell; or an NR cell.

18.-22. (canceled)

23. A method performed by a first network node co-located with a second network node for performing resource coordination with a third network node using the same frequency band as a first cell served by the first network node, the method comprising:
configuring (1110) a neighbour relation for a second cell served by the second network node, wherein the neighbour relation identifies at least one service to be used over an interface between the first cell and the second cell;
indicating the (1140) neighbour relation and the at least one service to the second network node; and
coordinating (1160) one or more resources with the second network node such that neighbouring cells between the first network node and the third network node can coexist on a shared channel.

24. The method of claim 23, wherein the first network node and the second network node being co-located comprises sharing the same base station in NR, gNB, in a split architecture.

25. A network node for configuring a neighbour relation between a first cell and a second cell for a specific service, the network node comprising:
processing circuitry (3302) configured to perform any of the steps of claim 1;
power supply circuitry (3308) configured to supply power to the processing circuitry.
